(19) United States
(12) Patent Application Publication
(10) Pub. No.: US 2026/0033919 A1
(43) Pub. Date: Feb. 5, 2026

(54) ORTHODONTIC APPLIANCE AND METHOD OF USE

(71) Applicant: Conrad Chou, Allen, TX (US)

(72) Inventor: Conrad Chou, Allen, TX (US)

(21) Appl. No.: 18/859,995

(22) PCT Filed: May 11, 2023
(86) PCT No.: PCT/US2023/021951

§ 371 Date: Oct. 25, 2024

(51) Int. Cl. A61C 7/20; A61C 7/00; A61C 7/14; A61C 7/16

(52) U.S. Cl. CPC A61C 7/20; A61C 7/002; A61C 7/145; A61C 7/16

(57) ABSTRACT

An orthodontic appliance comprises a combination of pre-made and custom elements to provide treatment versatility with minimized costs and time delays. The appliance comprises a pre-made arch member segment elastically deformed to removably attach to coupling units bonded to teeth. The appliance also comprises a connection module to further elastically deform the arch member segment to generate motive forces or to just connect separate arch member segments in variations. In another embodiment the appliance comprises pre-made connectors having one end attached to a tooth and another end elastically deformed to attach to an arch component. The attachment to teeth comprises coupling units bonded to teeth in variations. The arch components, coupling units, and connection modules may be custom made to match surfaces inside the mouth. Motive forces may be generated by the elastic deformation of the arch member segment, connectors, arch component, or connection module to align teeth.

### TECHNICAL FIELD

The present invention relates generally to an orthodontic appliance, and specifically, to an improved orthodontic appliance utilizing both custom elements and replaceable standard elements.

### BACKGROUND

Orthodontics is an area of dentistry focused on the correction of teeth and jaw irregularities to improve their function. Such correction commonly includes the repositioning of teeth and jaws from an abnormal alignment into a more normal position. Such treatment can provide many benefits, including improved aesthetics, improvements in hygiene, and correction of malocclusions.

Traditional orthodontic treatment has involved the use of what is commonly referred to as “braces” to align teeth. These devices commonly include brackets of various types affixed to an outer portion of teeth and connected through wire which is tightened to provide tension to guide and force the repositioning of teeth over time. In addition, accessories such as bands, hooks, elastics, and springs may be utilized to provide further adjustments, such as overbite or molar relationship correction. However, such conventional treatment methods have inherent difficulties, including common issues related to hygiene, aesthetics, comfort, long durations of treatment, and required frequent office visits.

More recently, orthodontic treatment has involved the use of removable aligners to reposition teeth to overcome some of the previous difficulties associated with traditional braces. These devices commonly include a series of custom-made flexible aligners, commonly called “trays,” which fit over the patient's teeth and place pressure on portions of the dental arches to gradually reposition teeth. Additionally, attachments, such as geometrically shaped buttons, can be bonded to specific teeth to help the aligners provide pressure to specific locations on the teeth. Moreover, elastics and hooks can also be used with aligners to provide further adjustments, such as overbite or molar relationship correction. However, such devices have inherent difficulties of their own. For example, customization adds to the expense and time it takes to make or replace trays when lost, which is possible due to their frequent removal. Additionally, use of such devices requires removal before eating and frequent brushing-after every meal-which can be inconvenient. Moreover, frequent office visits can be required to direct treatment because orthodontic forces may not be transmitted predictably with removable aligners. Lastly, frequent and extended removal subjects treatment outcome to patient compliance, which often to leads to complications and longer durations of treatment.

Accordingly, opportunities exist for an improved orthodontic device and method of use that overcomes the shortcomings in the art. In particular, it would be advantageous to have an orthodontic device and method that includes both pre-made elements and custom elements, which could be created, replaced, and installed in an inexpensive and timely manner at an orthodontist's office, for which removal isn't required to allow for normal eating, drinking, flossing, and brushing, which doesn't require frequent office visits, which minimizes device loss and damage, and which allows effective transmission of orthodontic forces.

### SUMMARY

This summary is provided to introduce in a simplified form concepts that are further described in the following detailed descriptions. This summary is not intended to identify key features or essential features of the claimed subject matter, nor is it to be construed as limiting the scope of the claimed subject matter.

In view of the above difficulties and limitations of the art, one purpose of the present invention is to provide a method and apparatus for orthodontic corrections. More specifically, the present invention relates to an orthodontic apparatus that includes both pre-made and custom elements that, in one or more embodiments, allows for inexpensive and timely creation, replacement, and installation, does not require removal for eating, drinking, brushing, or flossing, which minimizes inconvenience and risk of device damage or loss, does not require frequent office visits, and permits effective transmission of orthodontic forces. In certain aspects of the present invention, custom portions of the device may be created in office using 3-D printing technology-reducing the time it takes to make or replace the device. In further aspects of the invention, the device may be installed on a back or lingual portion of teeth, providing superior aesthetics. Moreover, the device may also be utilized with additional accessories and features to allow for further correction capability, in certain aspects of the present invention.

According to one or more embodiments, an orthodontic device comprises a pre-made arch member segment which is removably connected to coupling units affixed to the lingual surfaces of teeth. The pre-made arch member segment of the one or more embodiments may be selected from an array of various manufactured preset sizes, shapes, lengths, angulations, and configurations so that such segment follows a portion of the dental arch when teeth are in a desired position. Thereby, the pre-made arch member segments may be non-custom but merely selected based on use and circumstance. Though the pre-made arch member segments may be varied, the pre-made arch member of one or more embodiments comprises a generally sinuous shape having alternating peak and valley portions, identified as engaging portions (peaks) and body portions (valleys). The overall sinuous shape of the pre-made arch member segment makes it easy to floss as access to spaces between teeth is not blocked by a traditional orthodontic wire.

According to one or more embodiments, the engagement portion of the pre-made arch member segment is deflected into one or more channels in the surface of a coupling unit affixed to lingual surface of a tooth. Motive forces are transmitted from the pre-made arch member segments through the engaging portions to the coupling units and associated teeth to reposition such teeth. In one or more embodiments, an end of a pre-made arch member segment (in addition to engaging portions thereof), and potentially an end of an additional adjacent pre-made arch member segment may be connected to a single coupling unit. According to other embodiments, the ends of two pre-made arch member segments may be otherwise connected together by a connection module, which can be rigid, semi-rigid, or flexible. Also, according to one or more embodiments, the same connection module, which affixed the ends of pre-made arch members together, or additional connection modules may connect to one or more body portions of the pre-made arch member segments. Thereby, multiple pre-made arch member segments may be utilized. Also thereby, additional or modified motive forces may be transmitted to teeth. That is, the connection of two body portions through a connection module may change or create the forces transmitted to teeth by one or more pre-made arch member segments.

According to one or more embodiments, the coupling unit may be customized to engage the surface of a particular tooth more securely such as through a customized base. Similarly, a connection module may also be customized to include a surface specifically formed for contact with teeth, gum surfaces, or both, and another surface including channels or other engagement structures to receive the end or body portion of a pre-made arch member segment—in one or more embodiments. Thereby, in one or more embodiments, the orthodontic appliance may include customized elements which may be designed through digital imaging equipment and printed through 3-D printing equipment which may be provided in-house, cutting costs and reducing delays. Accordingly, the orthodontic appliance provides for the use of both custom and pre-made elements which reduces overall costs, delays, while providing further benefits mentioned before and inherent in the design of the device, such as effective biomechanics and versatile treatment planning.

According to certain other embodiments, the present orthodontic device comprises a custom arch component affixed to the lingual surface of teeth through pre-made connectors and an optional coupling unit. In various embodiments, the custom arch component is designed through digital imaging to have a surface which contacts a gum surface, a tooth surface, or both and have a shape which-when connected to pre-made connectors attached to teeth-transmits forces to reposition teeth. In various embodiments, the pre-made connectors have an engaging end-which may be deflected into channels, or other engagement structures, on the custom arch component—and a coupling end which may be affixed to a tooth through a customized coupling unit or directly with an adhesive such as a dental resin. The pre-made connectors may be selected from an array having various manufactured preset sizes, shapes, lengths, angulations, and configurations. Thereby, in one or more embodiments, the orthodontic appliance may include customized elements which may be designed through digital imaging equipment and printed through 3-D printing equipment which may be provided in-house, cutting costs and reducing delays. Accordingly, the orthodontic appliance provides for the use of both custom and pre-made elements which reduces overall costs, delays, while providing further benefits mentioned before and inherent in the design of the device, such as effective biomechanics and versatile treatment planning.

Though the prior embodiments discuss use of the various embodiments of an orthodontic apparatus on the lingual surface of teeth, it is foreseen that the orthodontic apparatus may contact and transmit force through a surface on the buccal side of teeth. Additionally, while the aforementioned embodiments discuss the use of channels on the coupling unit, connection module, and/or the arch component, it is foreseen that other structures and devices, such as protrusions and elastic ties, may be utilized to ensure removable connection between the associated structures. According to one or more embodiments, the shape and design of the structures might be configured to provide a slim profile relative to an inner surface of the mouth to provide comfort when installed.

In one or more embodiments, the method of creation and use associated with the device involves obtaining imaging data of the interior of a mouth, including teeth and gums, segmenting that data into individual teeth and gingival sections, manipulation of imaging data of an individual's teeth based on the segmented data into a final, desired configuration (i.e., creating a before and after configuration), virtually selecting and placing the aforementioned orthodontic device through virtual customization of the bases/surfaces of any coupling units, connection modules, and/or arch components to match the features of the teeth and/or gums they will contact, fabricating the customized portions based on the customizing features and shape/size of elements relative to the after configuration, bonding the coupling units and/or pre-made connectors to teeth with or without the use of positioning jigs, and removably connecting the all pre-made and custom elements to provide a motive force to connected teeth. In one or more embodiments, the method of obtaining imaging data and fabricating the custom elements involves the use of equipment which may be readily available at an orthodontic office, such as an intra-oral 3-D scanner and 3-D printer.

In one or more embodiments, the collection, segmenting of data, manipulation and addition of visual data and all virtual activities are carried out on a dedicated machine having at least a display and user interaction devices, such as a monitor and track pad or a touchscreen, controlled through user interface circuitry which responds to instructions received from a processor unit in communication with memory—where instructions, such as software, and data received might be saved and retrieved as required—and in communication with internal or networked imaging circuitry which utilizes imaging sensors to obtain imaging data inside a mouth. In alternative embodiments, one or more of the components involved in the collection, segmenting of data, manipulation and addition of visual data, and other virtual activities may be on a separate and/or non-dedicated device. Further, it is also foreseen that such components might require the transfer of data outside a network, including through portable storage mediums, such as a flash drive, external hard drive, USB storage device, CD or DVD.

Moreover, it is understood that the removable connection of components according to the prior method may include deflection of a pre-made arch member segment or pre-made connector so that an end, engaging portion, or body portion of pre-made arch member segment, or a coupling end, or engaging end of pre-made connector—as may be present and in need of connection according to the generated virtual data based on the after configuration-interacts with the coupling unit, arch component, or connection module. The coupling unit, arch component or connection module may also deflect to a lesser degree during the removable connection of components. Further, it is understood that a pre-made arch member segment or pre-made connector may be made of any elastic material, such as a polymer, thermoplastic, shape memory alloy, beta-titanium, or stainless steels. The custom coupling unit, arch component or connection module may be made of any rigid, semi-rigid, or elastic materials such as polymer.

In one example of use, an orthodontist might select a pre-made arch member segment and connect the engaging portions thereof to channels on the surface of coupling units affixed to teeth. The same orthodontist might also affix the ends of the pre-made arch member segments to one or more of channels in a coupling unit or a connection module. Additionally, to further generate desired directional motive forces, the orthodontist might connect the body portion of a pre-made arch member segment to another body portion of the same or different pre-made arch member segment with the use of connection module, which may affect the deflection of and thereby the orthodontic forces generated by pre-made arch member segment. In another example, an orthodontist might select pre-made connectors, attach the pre-made connectors to individual teeth with or without optional coupling units, and deflect the pre-made connectors and/or the arch component so that the engaging ends of the connectors affix to one or more channels or other engagement structures on the custom arch component.

### BRIEF DESCRIPTION OF THE DRAWINGS

The foregoing, as well as the following Detailed Description, is better understood when read in conjunction with the appended drawings. For the purposes of illustration, there is shown in the drawings exemplary embodiments; however, the presently disclosed subject matter is not limited to the specific methods and instrumentalities disclosed.

The embodiments illustrated, described, and discussed herein are illustrative of the present invention. As these embodiments of the present invention are described with reference to illustrations, various modifications or adaptations of the methods and or specific structures described may become apparent to those skilled in the art. It will be appreciated that modifications and variations are covered by the above teachings and within the scope of the appended claims without departing from the spirit and intended scope thereof. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

FIG. 1A illustrates a top plan view of an orthodontic appliance according to one or more embodiments including several pre-made arch member segments and custom coupling units installed on the lingual surface of teeth in a dental arch in a desired after configuration.

FIG. 1B illustrates a rear elevation view of an orthodontic appliance according to one or more embodiments of FIG. 1A.

FIG. 1C illustrates a top rear perspective view of an orthodontic appliance according to one or more embodiments of FIG. 1A.

FIG. 2 illustrates a top rear exploded view of an orthodontic appliance according to one or more embodiments of FIG. 1A.

FIG. 3A illustrates a top rear perspective view of three pre-made arch member segments of an orthodontic appliance according to one or more embodiments.

FIG. 3B illustrates a top plan view of three pre-made arch member segments of an orthodontic appliance according to one or more embodiments.

FIG. 4A illustrates a top rear perspective view of several custom coupling units of an orthodontic appliance according to one or more embodiments.

FIG. 4B illustrates a front perspective view of several custom coupling units of an orthodontic appliance according to one or more embodiments.

FIG. 4C illustrates a top rear perspective view of a single custom coupling unit of an orthodontic appliance according to one or more embodiments.

FIG. 4D illustrates a top front perspective view of a single custom coupling unit of an orthodontic appliance according to the embodiment of FIG. 4C.

FIG. 4E illustrates a top plan view of a single custom coupling unit of an orthodontic appliance according to the embodiment of FIG. 4C.

FIG. 4F illustrates a front elevation view of a single custom coupling unit of an orthodontic appliance according to the embodiment of FIG. 4C.

FIG. 5A illustrates a rear exploded view of two pre-made arch member segments and connection modules of an orthodontic appliance according to one or more embodiments.

FIG. 5B illustrates a rear perspective view of an orthodontic appliance affixed to teeth according to one or more embodiments including two pre-made arch member segments each with one end attached to coupling units and one end attached to a first connection module and a second connection module attached to several body portions of one of the arch member segments.

FIG. 5C illustrates a rear perspective view of two pre-made arch member segments and connection modules of an orthodontic appliance according to the embodiment of FIG. 5B with each arch member segment having an end attached to a first connection module and a second connection module attached to several body portions of one of the arch member segments.

FIG. 5D illustrates a front perspective view of two pre-made arch member segments and connection modules of an orthodontic appliance according to the embodiment of FIG. 5B.

FIG. 6A illustrates a top rear perspective view of an orthodontic appliance according to one or embodiments including a custom arch component and several pre-made connectors and coupling units installed on the lingual surface of teeth in a dental arch in a desired after configuration.

FIG. 6B illustrates a top plan view of an orthodontic appliance according to the embodiment of FIG. 6A.

FIG. 6C illustrates a rear elevation view of an orthodontic appliance according to the embodiment of FIG. 6A.

FIG. 7A illustrates a rear exploded view of an orthodontic appliance according to the embodiment of FIG. 6A.

FIG. 7B illustrates an exploded side perspective view of an orthodontic appliance according to the embodiment of FIG. 6A.

FIG. 8A illustrates a top perspective view of a custom arch component of an orthodontic appliance according to one or more embodiments.

FIG. 8B illustrates a side elevation view of a custom arch component of an orthodontic appliance according to the embodiment of FIG. 8A.

FIG. 8C illustrates a close-up side elevation view of a custom arch component of an orthodontic appliance according to the embodiment of FIG. 8A affixed to the engaging ends of several pre-made connectors of an orthodontic appliance according to one or more embodiments.

FIG. 8D illustrates a close-up side elevation view of several pre-made connectors of an orthodontic appliance according to one or more embodiments including coupling units affixed to the coupling ends thereof.

FIG. 9A illustrates a rear elevation view of several pre-made connectors of an orthodontic appliance according to one or more embodiments including coupling units affixed to the coupling ends thereof.

FIG. 9B illustrates a close-up view of two pre-made connectors of an orthodontic appliance according to the embodiment of FIG. 9A.

FIG. 9C illustrates a close-up view of two pre-made connectors of an orthodontic appliance according to the embodiment of FIG. 9A with the coupling units removed.

FIG. 9D illustrates a close-up top plan view of two pre-made connectors of an orthodontic appliance according to the embodiment of FIG. 9A with one of the two coupling units removed.

FIG. 10A illustrates a top plan view of an orthodontic appliance according to one or more embodiments including several custom arch components.

FIG. 10B illustrates a rear elevation view of the orthodontic appliance according to the embodiment of FIG. 10A.

### DESCRIPTION OF EMBODIMENTS ACCORDING TO THE INVENTION

The following description and figures are illustrative and are not to be construed as limiting. Numerous specific details are described to provide a thorough understanding of the disclosure. In certain instances, however, well-known or conventional details are not described in order to avoid obscuring the description. Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. It will be appreciated that same thing can be said in more than one way.

Alternative language and synonyms may be used for any one or more of the terms discussed herein. No special significance is to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only, and is not intended to further limit the scope and meaning of the disclosure or of any exemplified term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles may be used in the examples for convenience of a reader, which in no way should limit the scope of the disclosure.

### Overview of a First Embodiment

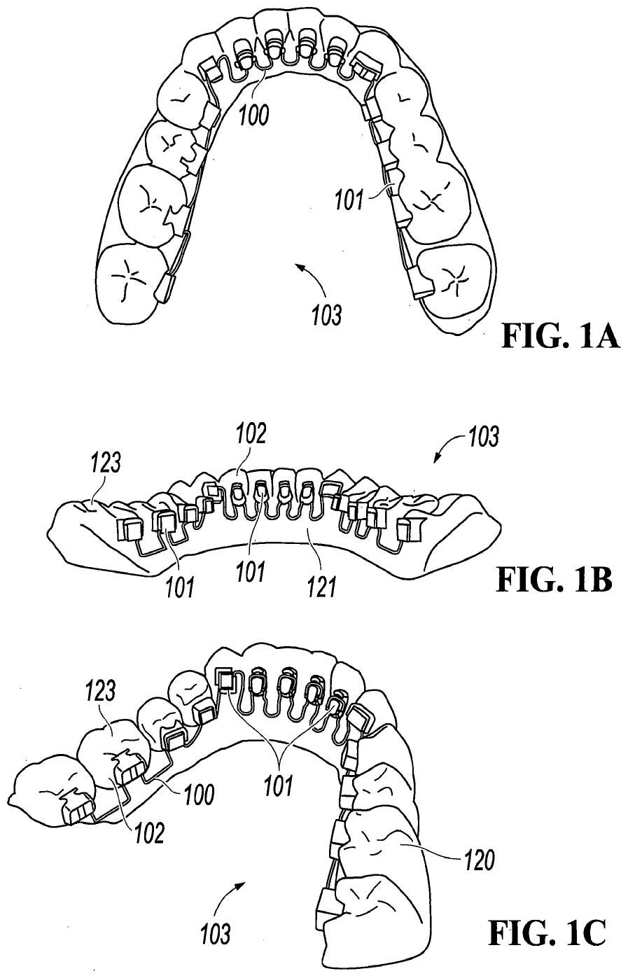

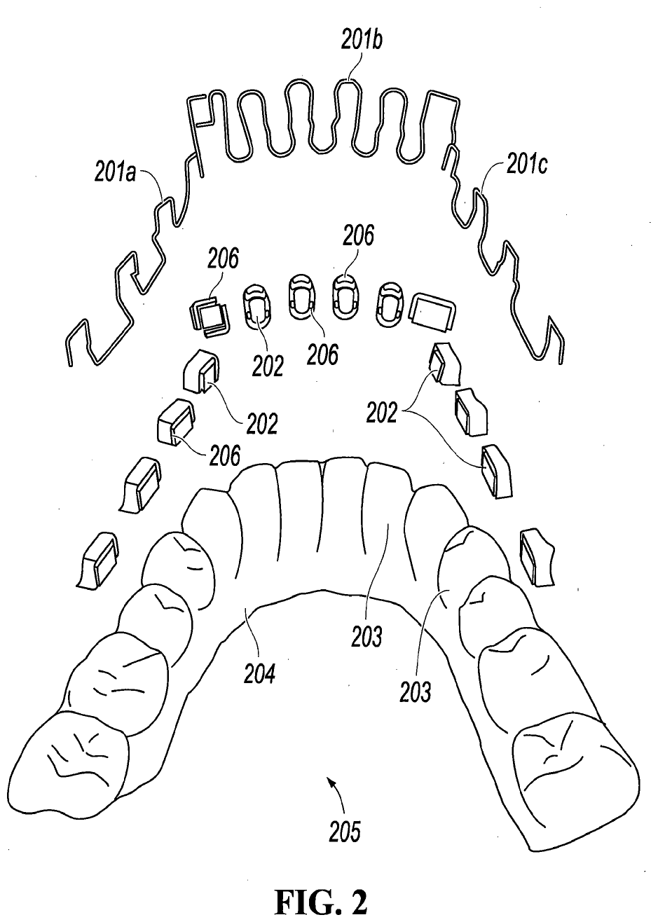

As will be described in greater detail below with reference to the figures, the subject matter described herein provides for methods and devices for provided orthodontic correction. As seen in FIGS. 1A-2, an orthodontic appliance is configured in accordance with one or more embodiments of the presently disclosed subject matter including pre-made arch member segments 100 to be attached to the lingual surface of teeth 102 in a dental arch 103 through coupling units 101. It is foreseen that the use of the above-described appliance, particularly on a lingual surface of teeth, will provide many benefits related to the ease of use—eating, brushing, flossing—and aesthetics—harder to see, allows for bleaching of buccal surfaces. Furthermore, the use of the above-described appliance may allow effective transmission of orthodontic forces directly from a pre-made arch member to the coupling units bonded to teeth, thereby reducing treatment duration and frequency of office visits.

### Pre-Made Arch Member Segments

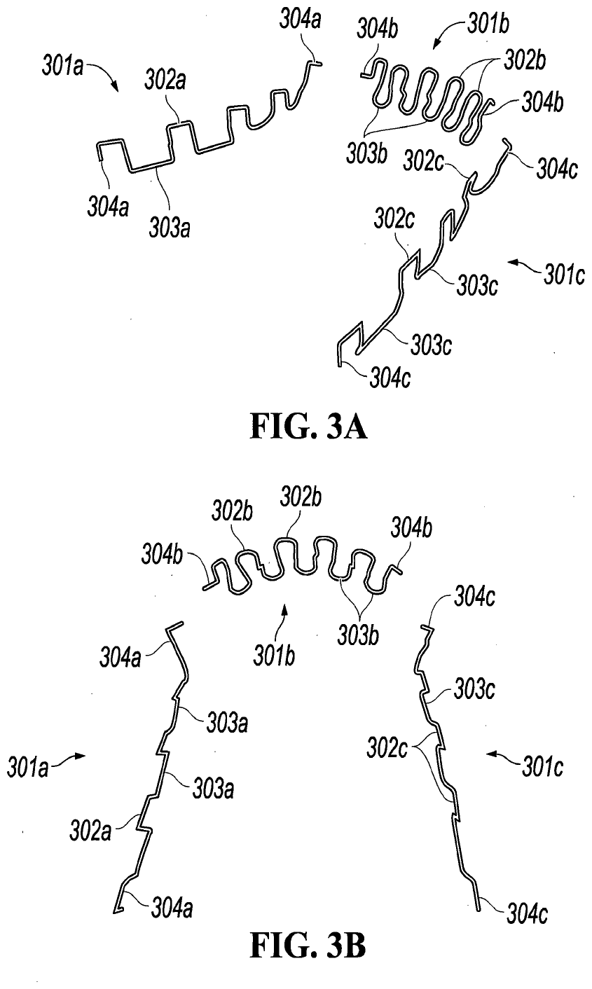

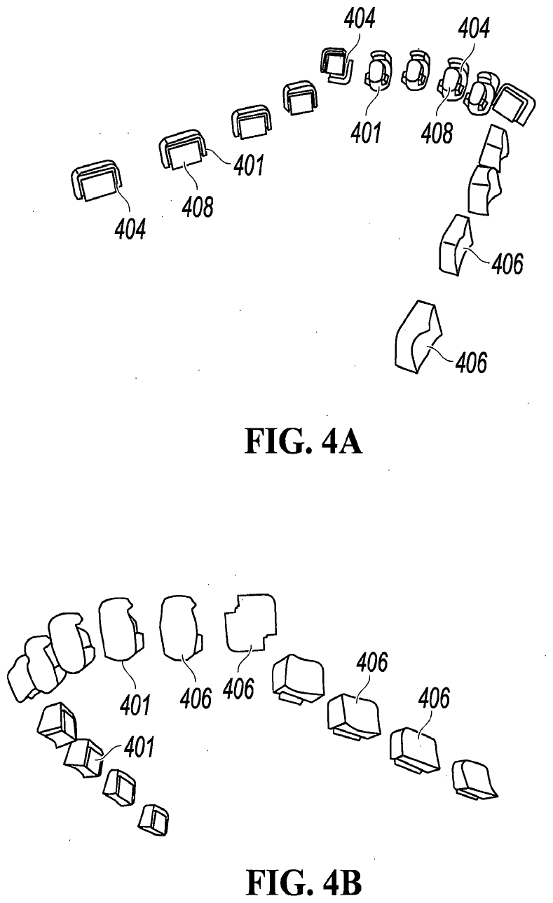

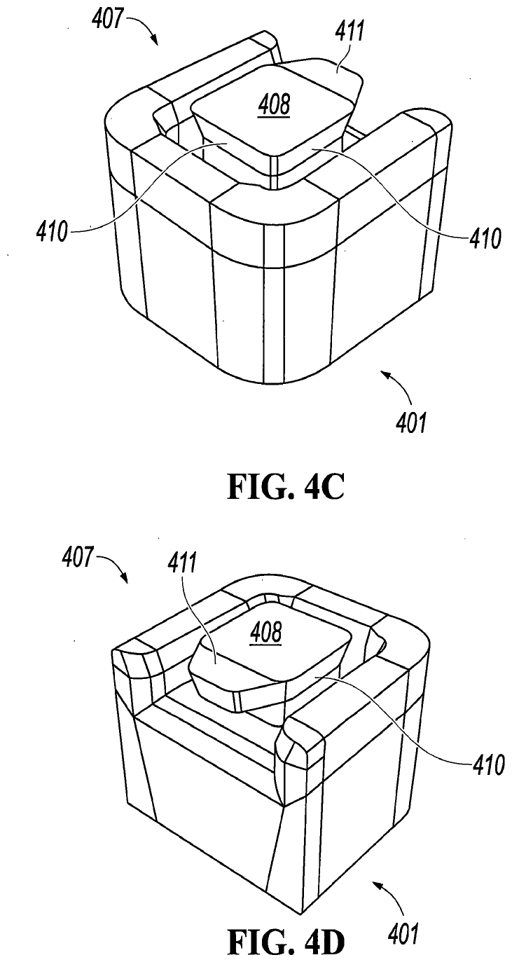

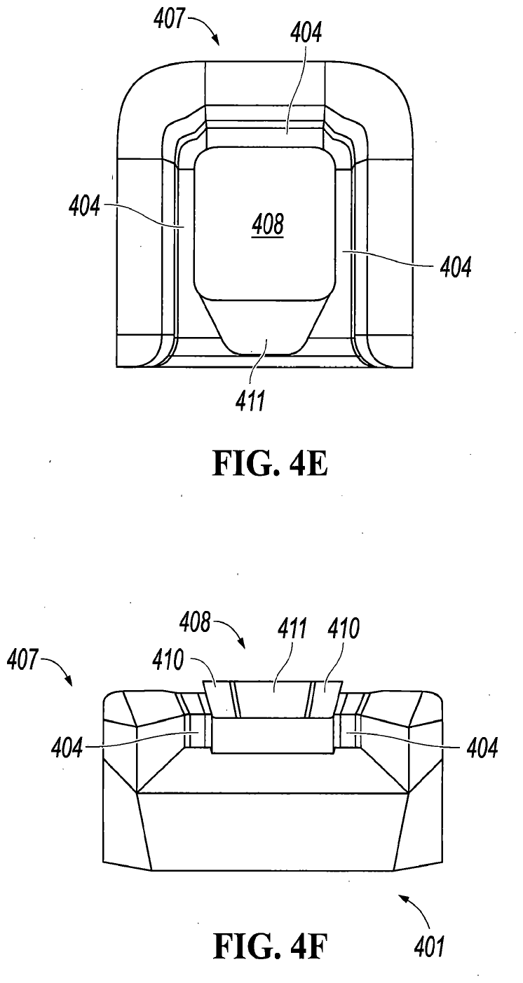

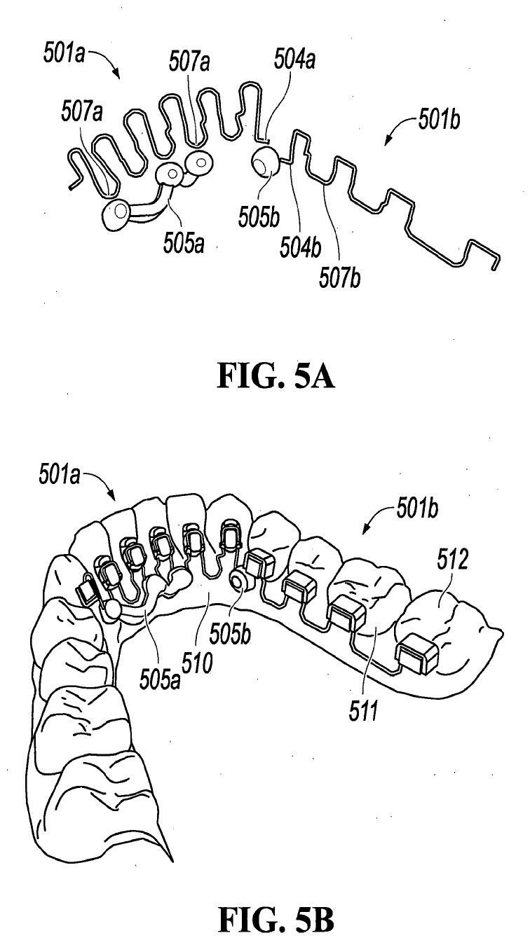

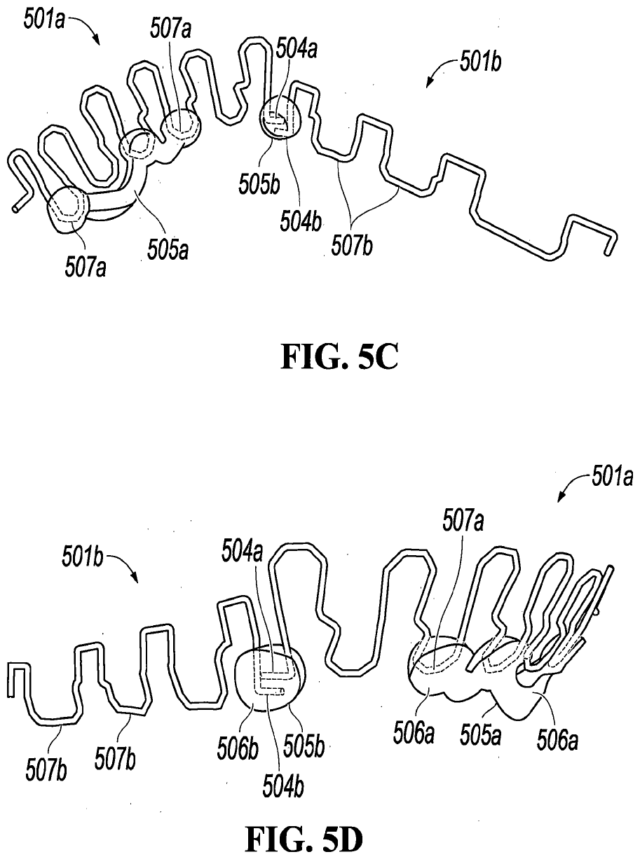

According to at least one embodiment, the orthodontic appliance may comprise pre-made arch member segments (201a, 201b, 201c) which are selectable from an array of pre-manufactured versions that include variations based on sizes, shapes, lengths, angulations, and configurations so that each selected pre-made arch member segment (201a, 201b, 201c) follows a portion of the buccal or lingual gum 204, teeth surface 203, or both in a dental arch 205 in a desired after configuration. According to at least one embodiment, the pre-made arch member segments (301a, 301b, 301c) may have a sinuous shape with peaks engaging portions (302a, 302b, 302c)—and valleys-body portions (303a, 303b, 303c)—and two ends (304a, 304b, 304c), as shown in FIGS. 3A-3B. As will be discussed in more detail hereafter, the engaging portions (302a, 302b, 302c) of a pre-made arch member segment (301a, 301b, 301c) can be deformed to connect to a coupling unit 202 described in FIGS. 2, such as by being inserted into a channel 404 on the surface 407 of the coupling unit 401 in certain embodiments shown in FIGS. 4A-4F. Similarly, the body portions (303a, 303b, 303c) of a pre-made arch member segment (301a, 301b, 301c) can be attached to one or more connection modules (505a, 505b) in various embodiments, as in FIGS. 5B-5D. Moreover, the ends (304a, 304b, 304c) of a pre-made arch member segment (301a, 301b, 301c) can be affixed to a coupling unit 401, similar to an engaging portion (302a, 302b, 302c), or to a connection module (505a, 505b), similar to a body portion (303a, 303b, 303c) in various embodiments. As shown in FIG. 5D, ends (504a, 504b) of two separate pre-made arch member segments (501a, 501b) can be connected together through a single connection module 505b in certain embodiments. The pre-made arch member segments (201a, 201b, 201c) are formed from a generally flexible material, such as a polymer, thermoplastic, shape memory alloy, beta-titanium, or stainless steels, so that they may be deformed to make various attachments described above, in certain embodiments. Though the pre-made arch member segments (100, 201a-c, 301a-c, 501a-b) shown in FIGS. 1A-5D are formed from a wire, it is also foreseen that other formations might be utilized, such as a band (i.e., flat ribbon of material) or a polymeric material that can be formed into various shapes of even or varied thickness through additive manufacturing such as 3D printing. The selection of the formation may be made based on comfort, such as by a desire to create a slimmer profile, and/or on the orthodontic forces required, such as by selecting a wire with a larger diameter or a polymeric shape with greater thickness to elicit larger forces when deflected. Moreover, it is to be understood that the pre-made arch member segment (100, 201a-c, 301a-c, 501a-b) may be replaced with another which-through changes in shape, size, lengths, angulations, or configurations—may change the motive forces on teeth.

### Coupling Units

According to at least one embodiment, the orthodontic appliance may comprise coupling units 202 which are customized to fit individual teeth on a lingual 203 or buccal surface. According to various embodiments, the coupling units 202 may be customized based on imaging data acquired from the interior of a mouth. Customization, in certain embodiments, bases the shape and size of a base portion 406 of the coupling unit 401 on surface features of individual teeth, so that the fit of the coupling unit is more secure and consistent as shown in FIGS. 4A-4B. The base 406 of the coupling unit 401 may be affixed to teeth through adhesive in certain embodiments and may be chemically or physically treated to increase the surface area of the base 406 to enhance the effectiveness of adhesive.

In various embodiments, the coupling unit has engagement structures 206 on one or more surfaces thereof to allow for the connection of pre-made arch member segments (201a, 201b, 201c). For example, as in FIG. 4A, the coupling unit 401 might have one or more connecting channels 404 formed therein to accept and secure portions of the pre-made arch member segments (201a, 201b, 201c) shown in FIG. 2. Although channels are shown on the coupling units in FIGS. 1A-5D, it is foreseen that the engagement structures might take other forms or use other elements. For example, the surface of a coupling unit might have a protrusion 408 which secures a portion of a pre-made arch member segment (201a, 201b, 201c), and the coupling unit 401 might also include the use of an optional elastic tie to secure a portion of the arch member segment (201a, 201b, 201c) to the coupling unit 401. Additionally, the protrusion 408 may include a tapered surface 410 and/or an overhanging structure 411 or tab to facilitate the insertion and securing of a portion of a pre-made arch member segment (201a, 201b, 201c) to the connecting channel 404 of coupling unit 401 as in FIGS. 4C-4F. In one embodiment, it is foreseeable that the opening of one or more channels 404 in the surface 407 of a coupling unit 401 might feature a tapered surface or one or more tabs which might deform or move to allow a portion of a pre-made arch member segment (201a, 201b, 201c) into the channel 404 and return to original position to prevent accidental removal thereof. Further, it is also foreseeable that optional elastic ties might be utilized with a coupling unit 401 utilizing any of the structures mentioned, including a tapered surface 410, to further secure portions inserted therein.

Moreover, it is understood that, in various embodiments the coupling units may be custom manufactured in an orthodontist's office with 3-D printer technology to cut down on delays and costs associated with custom manufacturing through an external location. Moreover, the use of in-office equipment also allows for more versatile treatment planning. In accordance with various embodiments, it is foreseen that the coupling units may be made of a polymer material. Moreover, it is also foreseen that multiple materials might also be utilized.

In addition, it is also foreseen that a custom coupling unit 401 might not be necessary for some teeth or, even any teeth. Instead, it is possible for adhesive to directly connect one or more engaging portions (302a, 302b, 302c) of the arch member segment (301a, 301b, 301c) to the surface of teeth 203 in various embodiments. However, it is understood that the use of coupling units 401, as described above, might provide the beneficial ability to removably connect engaging portions (302a, 302b, 302c) of the pre-made arch member segment (301a, 301b, 301c). Thereby, a pre-made arch member segment (301a, 301b, 301c) may be more easily replaced when damaged or changed entirely for one having different structural characteristics to change the motive forces on teeth. Additionally, though the prior embodiments discuss use of the various embodiments of an orthodontic apparatus on the lingual surface of teeth 203, it is foreseen that the orthodontic apparatus may contact and transmit force through a surface on the buccal side of teeth 120, gum 121, or both, and/or a surface on the occlusal portion 123 of teeth. It is also foreseen that not every tooth will require the attachment of an engaging portion (302a, 302b, 302c) thereto with or without a coupling unit 202, so that not every tooth in a dental arch 103 is connected thereto; likewise, not every tooth is required to interact with a connection module (505a, 505b), which will be described hereafter, so that not every tooth in a dental arch is fitted thereto.

### Connection Module

According to at least one embodiment, the orthodontic appliance may comprise connection modules (505a, 505b) which may be customized to also fit the surfaces of teeth 511, gums 510, or both, such as those shown in FIGS. 5A-5D. Moreover, the connection module (505a, 505b) may also be customized to connect two pre-made arch member segments (501a, 501b) in at least one embodiment. According to various embodiments, the connection modules (505a, 505b) may be customized based on imaging data acquired from the interior of a mouth and may be customized based on the desired locations of the pre-made arch member segments (501a, 501b) and their components thereof in a desired after configuration of teeth. Customization, in certain embodiments, bases the shape, size, and features of a surface (506a, 506b) of the connection module (505a, 505b) on the surface features of teeth 511, gums 510, or both so that the fit of the connection module (505a, 505b) is more comfortable, as shown in FIGS. 5B-5D. In one or more embodiments, the connection modules (505a, 505b) may be utilized to connect portions of one or more pre-made arch member segments (501a, 501b). The portions of the pre-made arch member segment connected may include the body portion 507a and/or the ends (504a, 504b) thereof, as shown in FIGS. 5B-5D.

For example, the ends (504a, 504b) of two pre-made arch member segments (501a, 501b) may be otherwise connected together by a connection module 505b. Also, according to one or more embodiments, the same connection module 505b, which affixed the ends (504a, 504b) of pre-made arch members (501a, 501b) together, or additional connection modules 505a, may connect to one or more body portions (507a, 507b) of the pre-made arch member segments (501a, 501b). Thereby, multiple pre-made arch member segments (501a, 501b) may be utilized together. It is understood that the connection module (505a, 505b) may be rigid, semi-rigid, or flexible. Also thereby, additional or modified motive forces may be transmitted to teeth. That is, the connection of the ends (504a, 504b) of two pre-made arch member segments, two body portions (507a, 507b), or one end to a body portion through a connection module (505a, 505b) may change or create the forces transmitted to teeth by one or more pre-made arch member segments (501a, 501b). It can also be understood that the attachment of the connection module (505a, 505b) to the body portion 507a or end (504a, 504b) of a pre-made arch member may be permanent, where the body portion 507a or end (504a, 504b) of a pre-made arch member may be embedded within the connection module (505a, 505b), or removable, where the connection module (505a, 505b) may include channels or engagement structures on a surface to receive and secure the body portion 507a or end (504a, 504b) of a pre-made arch member.

It can be foreseen that a connection module (505a, 505b) may include additional accessory structures such as additional channels, hooks, and protrusions to allow attachment of orthodontic accessories such as springs, elastic bands, and wire segments. Connection module (505a, 505b) may also include additional accessory structures such as recesses, apertures, and openings to allow engagement of other orthodontic accessories such as buttons, hooks, or brackets attached to the teeth, and abutments, hooks, or plates attached to dental implants, which are implanted in the dental jawbone. It can be understood that these additional accessory structures may be materially continuous with the connection module (505a, 505b) or may be attached to the connection module (505a, 505b) with the use of, for example, an adhesive. Furthermore, a connection module (505a, 505b) may extend its fitting beyond the buccal or lingual surfaces 511 of the teeth to fit the occlusal surfaces 512 of the teeth, which may serve to provide additional stability when the connection module (505a, 505b) is installed in a patient's mouth, to change the patient's bite to allow certain orthodontic movements such as lingual tipping of the incisors, or to aid posturing of the lower jaw. Thereby, it can also be foreseen that the portions of a connection module (505a, 505b) fitted to interface a tooth surface may removably interact with or be attached to the surfaces of teeth with the use of, for example, an adhesive. Additionally, it can also be foreseen that when a connection module (505a, 505b) is installed in a patient's palate, some portions of the connection module may occlude with the patient's lower teeth, as commonly seen in patients with deep bite, and thereby change the way patient bites, which may be required for certain orthodontic movements. Furthermore, a connection module (505a, 505b) may be materially continuous with or be attached to components of another orthodontic appliance, which may interact with different portions of the dental arch, such as the occlusal polymeric splint component of a bonded expander, or the custom arch component 601 of another embodiment of the present orthodontic appliance, such as that of the second embodiment described below in this disclosure.

Moreover, it is understood that, in various embodiments the connection modules (505a, 505b) may be custom manufactured in an orthodontist's office with 3-D printer technology to cut down on delays and costs associated with custom manufacturing through an external location. Moreover, the use of in-office equipment also allows for more versatile treatment planning. In accordance with various embodiments, it is foreseen that the connection modules (505a, 505b) may be made of a polymer material and may be made rigid, semi-rigid, or flexible. Moreover, it is also foreseen that multiple materials might also be utilized.

### Overview of a Second Embodiment

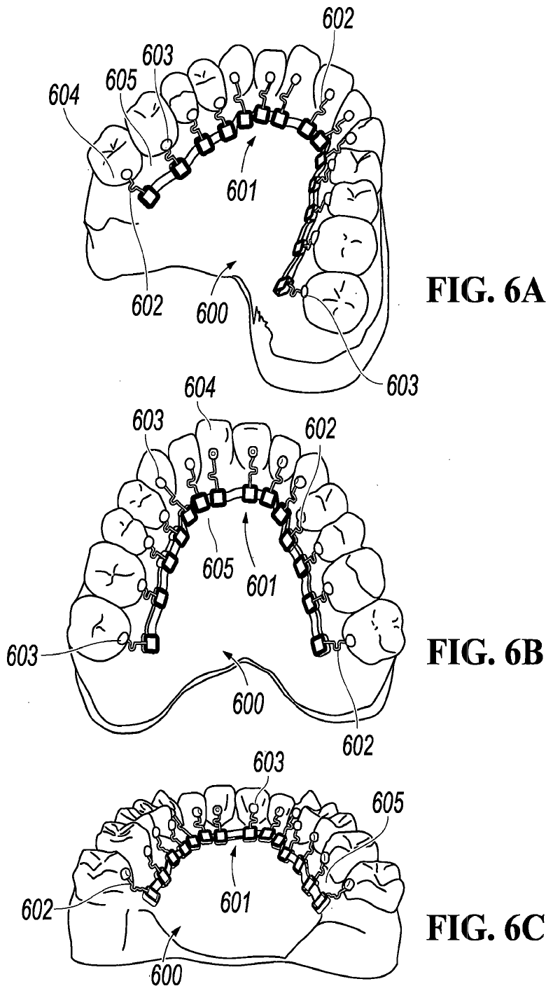

As will be described in greater detail below with reference to the figures, the subject matter described herein provides for methods and devices for provided orthodontic correction. As seen in FIGS. 6A-10B, an orthodontic appliance is configured in accordance with one or more embodiments of the presently disclosed subject matter including pre-made connectors 602 to be attached to the lingual surface 604 of teeth in a dental arch through coupling units 603. It is foreseen that the use of the above-described appliance, particularly on a lingual surface 604 of teeth, will provide many benefits related to the ease of use—eating, brushing, flossing—and aesthetics—harder to see, allows for bleaching of buccal surfaces. Furthermore, the use of the above-described appliance may allow effective transmission of orthodontic forces from the pre-made connectors 602 to the teeth, thereby reducing treatment duration and frequency of office visits.

### Pre-Made Connectors

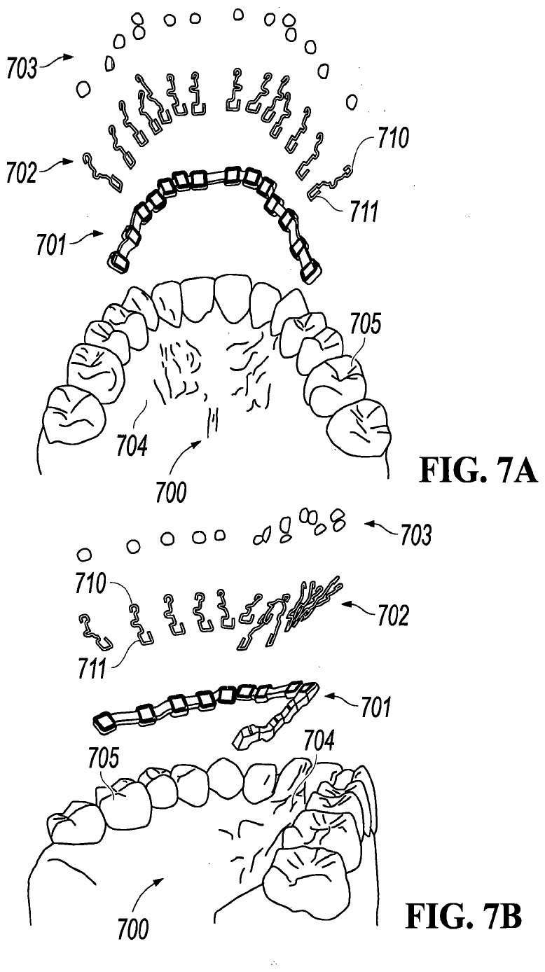

According to at least one embodiment, the orthodontic appliance may comprise pre-made connectors 602 which are selectable from an array of pre-manufactured versions that include variations based on sizes, shapes, lengths, angulations, and configurations so that each selected pre-made connector 602 follows a portion of the buccal or lingual teeth surface 604, gum surface 605, or both in a dental arch 600 in a desired after configuration. According to at least one embodiment, the pre-made connectors 602 may have two ends, which are illustrated in FIG. 7, a coupling end 710 to be affixed adjacent to teeth and an engaging end 711 to be affixed to a custom arch component 601. As will be discussed in more detail hereafter, the coupling end 710 of a pre-made connector 602 can be deformed to connect to a coupling unit 603, such as by being inserted into a channel on the surface of the coupling unit 603 in certain embodiments. Similarly, the engaging end 711 of a pre-made connector 602 can be deformed to connect to one or more custom arch components 601 in various embodiments, as in FIGS. 6A-6C.

The pre-made connectors 602 are formed from a generally flexible material so that they may be deformed to make various attachments described above, in certain embodiments. Though the pre-made connectors 602 shown in FIGS. 6A-10B are formed from a wire, it is also foreseen that other formations might be utilized, such as a band (i.e., flat ribbon of material) or a polymeric material that can be formed into various shapes of even or varied thickness through additive manufacturing, such as 3D printing. The selection of the formation may be made based on comfort, such as by a desire to create a slimmer profile, and/or on the orthodontic forces required, such as by selecting a wire with a larger diameter or a polymeric shape with greater thickness to elicit larger forces when deflected. Moreover, it is to be understood that the pre-made connector 602 may be replaced with another which-through changes in shape, size, lengths, angulations, or configurations—may change the motive forces on teeth.

### Custom Arch Component

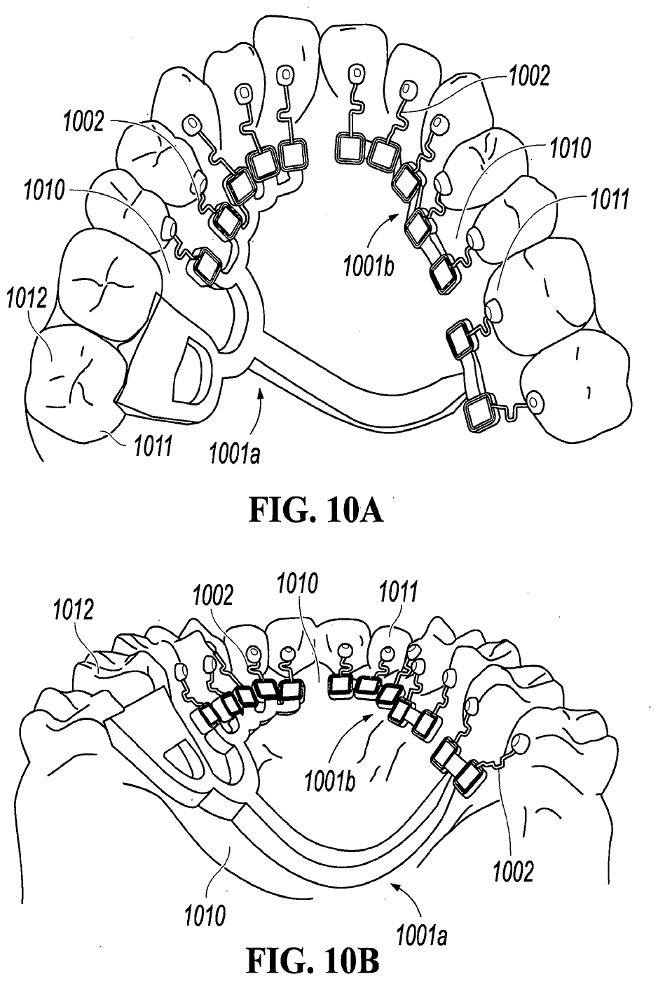

According to at least one embodiment, the orthodontic appliance may comprise one or more custom arch components 701 which are customized to generally fit the buccal or lingual/palatal gum surface 704, teeth surface 705, or both in a dental arch 700 as shown in FIGS. 7A-B. In certain embodiments, one or more custom arch components 701 may be customized to fit the gum surface 704 near the buccal or lingual surface 705 of teeth in a dental arch 700 in a desired after configuration. According to various embodiments, the arch components 701 may be customized based on imaging data acquired from the interior of a mouth. Customization, in certain embodiments, bases the shape and size of a surface of the arch component 701 on surface features of the gum area 704, adjacent teeth 705, or both so that the fit of the arch component is more comfortable and consistent as shown in FIGS. 6A-6C and FIGS. 10A-10B.

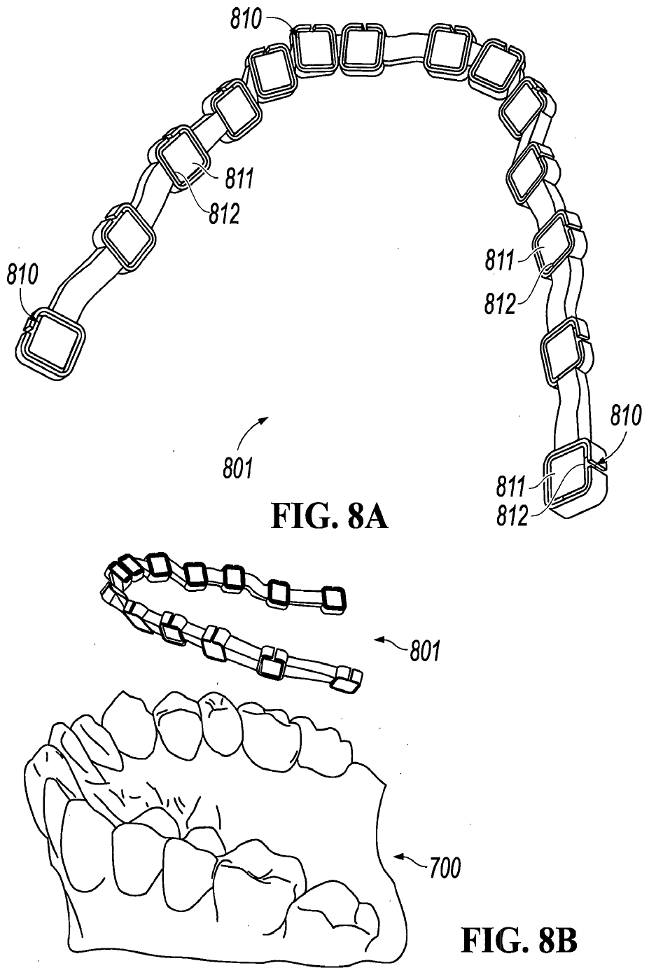

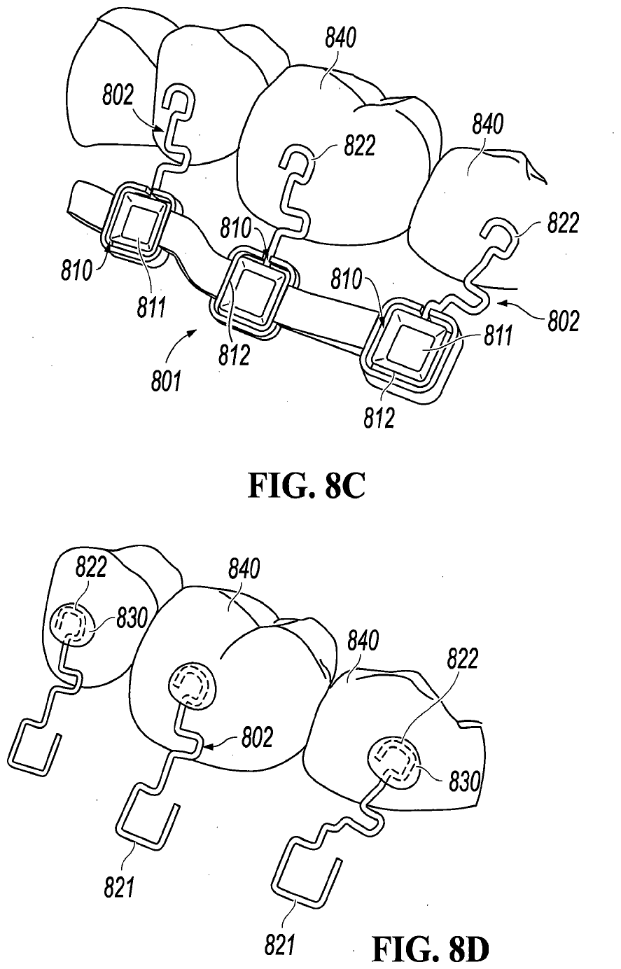

In various embodiments, the arch component 701 has engagement structures on one or more surfaces thereof to allow for the connection of pre-made connectors 702. For example, as in FIGS. 7A-8B, the arch components 801 might have one or more connecting channels 810 formed therein to accept and secure engaging ends 711 of the pre-made connectors 702. Although channels 810 are shown on the arch components in FIGS. 6A-8D, it is foreseen that the engagement structures might take other forms or use other elements. For example, a surface of an arch component 801 might have protrusions 811 which secure the engaging ends 711 of the pre-made connectors 702, and the arch component 801 might also optionally include the use of elastic ties to secure the engaging ends 711 of the pre-made connectors 702 to the arch component 701. Additionally, the protrusion 811 may include a tapered surface or overhanging structure 812 or tab to facilitate the insertion and securing of the engaging end 821 of a pre-made connector 802 in the connecting channel 810 as shown in FIGS. 8A-D. The engaging ends 821 of pre-made connectors 802 are hidden in FIG. 8C to better display the connecting channels 810 and protrusions 811 of the arch component 801. FIG. 8D illustrates that the engaging ends 821 of pre-made connectors 802 generally follow the course of the connecting channels 810 shown in FIG. 8C. FIG. 8D further shows that that the coupling ends 822 of pre-made connectors 802 may be connected to one or more coupling units 830, which are affixed to teeth surface 840, such that the pre-made connectors 802 may be positionally stable without the engagement with the arch component 801 and immobile with respect to teeth surface 840. In one embodiment, it is foreseeable that the opening of one or more channels 810 in the surface of an arch component 801 might also feature a tapered surface or one or more tabs which might deform or move to allow the engaging end 821 of a pre-made connector 802 into the channel 810 and return to original position to prevent accidental removal thereof. Further, it is also foreseeable that optional elastic ties might be utilized with a custom arch component 801 and/or coupling unit 830 utilizing any of the structures mentioned, including a tapered surface or overhanging structure 812, to further secure portions inserted therein.

Moreover, it is understood that, in various embodiments the arch components 801 may be custom manufactured in an orthodontist's office with 3-D printer technology to cut down on delays and costs associated with custom manufacturing through an external location. Moreover, the use of in-office equipment also allows for more versatile treatment planning. In accordance with various embodiments, it is foreseen that the arch components 801 may be made of a polymer material and may be made rigid, semi-rigid, or flexible. Moreover, it is also foreseen that multiple materials might also be utilized.

In addition, it is also foreseen that multiple custom arch components (1001a, 1001b) might be utilized as shown in FIGS. 10A-10B. Accordingly, specific areas of the dental arch including the gingiva 1010 may be targeted. It is also foreseen that not every tooth will require the attachment of a pre-made connector 1002 thereto, so that not every tooth in a dental arch is connected thereto as shown in FIGS. 10A-10B; instead, a tooth surface 1011 and/or gum surface 1010 may directly interact with the custom arch component 1001a. Likewise, not every tooth and its surrounding gum surface will interact with the custom arch component (1001a, 1001b), so that not every tooth in a dental arch is fitted thereto. In other words, a custom arch component (1001a, 1001b) may fit only limited areas of the lingual/palatal or buccal gum surface 1010, teeth surface 1011, or both. Furthermore, it is understood that a custom arch component (1001a, 1001b) may be rigid, semi-rigid, or flexible and may be of various shapes, sizes, thickness, and configurations, as shown by FIGS. 10A-10B. Thereby, additional or modified motive forces may be transmitted from the custom arch component (1001a, 1001b) directly or via the pre-made connectors 1002 to the teeth. That is, changing the shapes, sizes, thickness, or configurations of a custom arch component (1001a, 1001b) may change or create the forces transmitted to teeth directly or via one or more pre-made connectors 1002.

It can be foreseen that a custom arch component (1001a, 1001b) may include additional accessory structures such as additional channels, hooks, and protrusions to allow attachment of orthodontic accessories such as springs, elastic bands, and wire segments. Custom arch component (1001a, 1001b) may also include additional accessory structures such as recesses, apertures, and openings to allow engagement of other orthodontic accessories such as buttons, hooks, or brackets attached to the teeth, and abutments, hooks, or plates attached to dental implants, which are implanted in the dental jawbone. It can be understood that these additional accessory structures may be materially continuous with the custom arch component (1001a, 1001b) or may be attached to the custom arch component (1001a, 1001b) with the use of, for example, an adhesive. Furthermore, a custom arch component (1001a, 1001b) may extend its fitting beyond the buccal or lingual surfaces of the teeth 1011 to fit the occlusal surfaces 1012 of the teeth, which may serve to provide additional stability when the custom arch component is installed in a patient's mouth, to change the patient's bite to allow certain orthodontic movements such as lingual tipping of the incisors, or to aid posturing of the lower jaw. Thereby, it can also be foreseen that the portions of a custom arch component (1001a, 1001b) fitted to interface a tooth surface may be attached to the surfaces of teeth with the use of, for example, an adhesive. Additionally, it can also be foreseen that when a custom arch component (1001a, 1001b) is installed in a patient's palate, some portion of the custom arch component (1001a, 1001b) may occlude with the patient's lower teeth, as commonly seen in patients with deep bite, and thereby change the way patient bites, which may be required for certain orthodontic movements. Furthermore, a custom arch component (1001a, 1001b) may be materially continuous with or be attached to components of another orthodontic appliance, which may interact with different portions of the dental arch, such as the occlusal polymeric splint component of a bonded expander, or a connection module (505a, 505b) of another embodiment of the present orthodontic appliance, such as that of the first embodiment specified above in this disclosure. Based on the above and the fact these arch components (1001a, 1001b) are custom made in office, the versatility of treatment is greatly improved.

### Coupling Unit

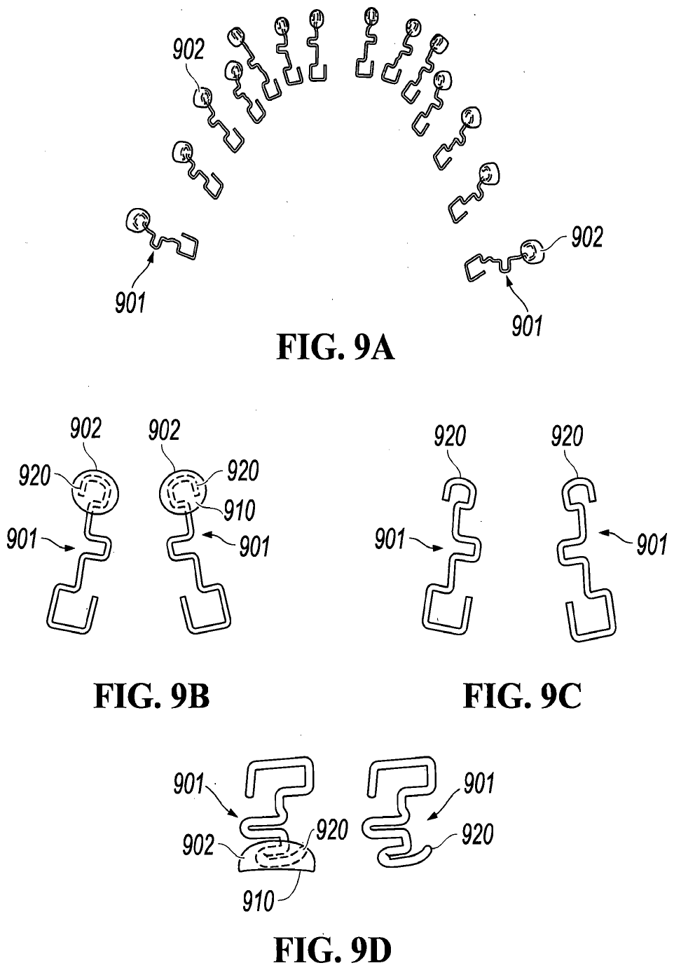

According to at least one embodiment, the orthodontic appliance may comprise coupling units 703 which are customized to fit individual teeth on a lingual or buccal surface 705. According to various embodiments, the coupling units 703 may be customized based on imaging data acquired from the interior of a mouth. Customization, in certain embodiments, bases the shape and size of a base portion 910 of the coupling unit 902 on surface features of individual teeth, so that the fit of the coupling unit is more secure and consistent, as shown in FIGS. 9B and 9D. The base 910 of the coupling unit 902 may be affixed to teeth through adhesive in certain embodiments.

In various embodiments, the coupling unit 902 has engagement structures on one or more surfaces thereof to allow for the connection of a pre-made connector 901. For example, the coupling unit 902 might have one or more connecting channels or housings formed therein to accept and secure the coupling end 920 of the pre-made connector 901 with or without adhesive. Alternatively, the coupling ends 920 of pre-made connectors 901 can be embedded in channels or housings of coupling units 902, as in FIGS. 9A-B and 9D. Further, it is foreseen that the engagement structures might take other forms or use other elements. For example, the surface of a coupling unit 902 might have a protrusion which secures the coupling end 920 of a pre-made connector 901, and the coupling unit 902 might also optionally include the use of an elastic tie to secure the coupling end 920 of a pre-made connector 901 to the coupling unit 902. It is foreseen that the engagement structures may be located in or integral with the base 910 of the coupling unit 902, so that both the engagement structures and the base 910 are customized to fit a lingual or buccal surface 705 of a tooth. Additionally, the protrusion may include a tapered surface or overhanging structure or tab to facilitate the insertion and securing of a pre-made connector 901 in the coupling unit 902. Moreover, it is also foreseeable that the opening of one or more channels in the surface of a coupling unit 902 might also feature a tapered surface or one or more tabs which might deform or move to allow the coupling end 920 of a pre-made connector 901 into the channel and return to original position to prevent accidental removal thereof. Further, it is also foreseeable that optional elastic ties might be utilized with a coupling unit 902 utilizing any of the structures mentioned, including a tapered surface or overhanging structure, to further secure portions inserted therein.

Moreover, it is understood that, in various embodiments the coupling units 902 may be custom manufactured in an orthodontist's office with 3-D printer technology to cut down on delays and costs associated with custom manufacturing through an external location. Moreover, the use of in-office equipment also allows for more versatile treatment planning. In accordance with various embodiments, it is foreseen that the coupling units 902 may be made of a polymer material. Moreover, it is also foreseen that multiple materials might also be utilized.

In addition, it is also foreseen that a custom coupling unit 902 might not be necessary for some teeth or, even any teeth. Instead, it is possible for adhesive to directly connect one or more coupling ends 920 of the pre-made connectors 901 to the surface of teeth 705 in various embodiments, especially with the aid of positioning jigs. However, it is understood that the use of coupling units 902, as described above, might provide the beneficial ability to removably connect the coupling ends 920 of pre-made connectors 901. Thereby, a pre-made connector 901 may be replaced when damaged or changed entirely for one having different structural characteristics to change the motive forces on teeth. It is also understood that a custom coupling unit 902, wherein the coupling end 920 of a pre-made connector 901 is pre-attached to one or more engagement structures at the base 910 of the coupling unit 902, may be directly bonded to the surface of a tooth 705, such that the custom coupling unit 902, the coupling end 920 of a pre-made connector 901, and the tooth are immovable with respect to one another. However, it is also foreseen that the array of pre-made connectors 901 might be provided with coupling units 902 already affixed thereto, as one integral unit in some embodiments. Thereby, a wide variety of possibilities is foreseen such that coupling units 902 may be provided or not and, if provided, may be integrally formed (not custom made) with the pre-made connector 901, or custom made and applied.

### Creation and Use Method

In one or more embodiments, the method of creation and use associated with the device involves obtaining imaging data of the interior of a mouth, including teeth and gums, segmenting that data into individual teeth and gingival sections, manipulation of imaging data of an individual's teeth based on the segmented data into a final, desired configuration (i.e., creating a before and after configuration), virtually selecting and placing the pre-made arch member segments and/or pre-made connectors to fit or match the features of the teeth and/or gums in the after configuration, virtually selecting and placing the aforementioned custom made orthodontic elements through virtually customizing the bases/surfaces of any coupling units, connection modules, and/or arch components to match the features of the teeth and/or gums that will be in contact, fabricating the customized orthodontic elements or portions therein based on the customizing features and shape/size of elements relative to the after configuration, bonding the coupling units and/or pre-made connectors to teeth, and connecting the aforementioned elements, which may include pre-made arch member segments, pre-made connectors, connection modules and/or arch components, to provide a motive force to connected teeth. In one or more embodiments the method of obtaining imaging data and fabricating the custom elements involves the use of equipment which may be readily available at an orthodontic office, such as an intra-oral 3-D scanner and 3-D printer.

In one or more embodiments, the collection, segmenting of data, manipulation and addition of visual data and all virtual activities are carried out on a dedicated machine having at least a display and user interaction devices, such as a monitor and track pad or a touchscreen, controlled through user interface circuitry which responds to instructions received from a processor unit in communication with memory—where instructions, such as software, and data received might be saved and retrieved as required—and in communication with internal or networked imaging circuitry which utilizes imaging sensors to obtain imaging data inside a mouth. In alternative embodiments, one or more of the components involved in the collection, segmenting of data, manipulation and addition of visual data, and other virtual activities may be on a separate and/or non-dedicated device. Further, it is also foreseen that such components might require the transfer of data outside a network, including through portable storage mediums, such as a flash drive, external hard drive, USB storage device, CD or DVD.

Accordingly, through the application of this orthodontic appliance motive force is provided to teeth to move teeth from a first before configuration to a desired after configuration. In one or more embodiments, the motive force is generated by the characteristics of one or more pre-made arch member segments or pre-made connectors, such as by the length of such elements. In one or more embodiments, motive force can be additionally, or in the alternative, provided by the characteristics of an attached connection module or arch component, such as by the shape thereof. Thereby, both custom elements and pre-set elements can provide or alter motive force allowing wide versatility in treatment plans and capabilities. Moreover, the use of this orthodontic appliance provides significant beneficial increases in aesthetics, ease of use, cost savings, and availability while providing effective motive forces to adjust teeth. Further, there is no risk of losing this device, as with user removable orthodontic devices.

### Additional Elements

In one or more embodiments, the orthodontic appliance may be affixed to the buccal portion of teeth, in the alternative of the lingual portion. Moreover, in certain embodiments, the orthodontic appliance can utilize soft tissue areas, such as gingival surface as anchorage points to help provide motive forces. Further, in certain embodiments, the orthodontic appliance might also include attachments for the inclusion of auxiliary elastic or spring components. Additionally, it is foreseen that the present orthodontic appliance in one or more embodiments may incorporate occlusal, bite plate, functional, and/or orthotic features. Also, it is foreseen that various embodiments might also include habit correction accessories, such as rough portions to dissuade tongue contact. Based on the above, it is also foreseen that in certain embodiments one or more of the coupling units, engaging portions of a pre-made arch member segment, ends of pre-made arch member segment and/or coupling ends of pre-made connectors might be connected to a particular tooth through connection to a band around that particular tooth.

As will be appreciated by one skilled in the art, aspects of the present invention may be embodied as a system, method, or computer program product. Accordingly, aspects of the present invention may take the form of an entirely hardware embodiment. Any combination of one or more computer readable medium(s) may be utilized. The computer readable medium may be a computer readable signal medium or a computer readable storage medium (including, but not limited to, non-transitory computer readable storage media). A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

Computer program code for conducting operations for aspects of the present invention may be written in any combination of one or more programming languages, including an object-oriented programming language such as Java, Smalltalk, C++, or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter situation scenario, the remote computer may be connected to the user's computer through any type of network, including a local area network (LAN) or a wide area network (WAN), or the connection may be made to an external computer (for example, through the Internet using an Internet Service Provider).

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in a flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in a flowchart and/or block diagram block or blocks.

As will be appreciated by one skilled in the art, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any dimensions expressed or implied in the drawings and these descriptions are provided for exemplary purposes. Thus, not all embodiments within the scope of the drawings and these descriptions are made according to such exemplary dimensions. The drawings are not made necessarily to scale. Thus, not all embodiments within the scope of the drawings and these descriptions are made according to the apparent scale of the drawings with regard to relative dimensions in the drawings. However, for each drawing, at least one embodiment is made according to the apparent relative scale of the drawing.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present inventive subject matter. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

It will be understood that when an element or layer is referred to as being “on” another element or layer, the element or layer can be directly on another element or layer, or intervening elements or layers may also be present. In contrast, when an element is referred to as being “directly on” another element or layer, there are no intervening elements or layers present. As used herein, the term “and/or” includes any and all combinations of one or more of the associated listed items.

Spatially relative terms, such as “below,” “beneath,” “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation, in addition to the orientation depicted in the figures. Throughout the specification, like reference numerals in the drawings denote like elements.

Embodiments of the inventive subject matter are described herein with reference to plan and perspective illustrations that are schematic illustrations of idealized embodiments of the inventive subject matter. As such, variations from the shapes of the illustrations as a result, for example, of manufacturing techniques and/or tolerances, are to be expected. Thus, the inventive subject matter should not be construed as limited to the particular shapes of objects illustrated herein, but should include deviations in shapes that result, for example, from manufacturing. Thus, the objects illustrated in the figures are schematic in nature and their shapes are not intended to illustrate the actual shape of a region of a device and are not intended to limit the scope of the inventive subject matter.

The terminology used herein is for the purpose of describing particular embodiments only and is not intended to be limiting of the present inventive subject matter. As used herein, the singular forms “a,” “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present inventive subject matter belongs. It will be further understood that terms used herein should be interpreted as having a meaning that is consistent with their meaning in the context of this specification and the relevant art and will not be interpreted in an idealized or overly formal sense unless expressly so defined herein. The term “plurality” is used herein to refer to two or more of the referenced items. Although any methods, devices, and materials similar or equivalent to those described herein can be used in the practice or testing of the presently disclosed subject matter, representative methods, devices, and materials are now described.

In the drawings and specification, there have been disclosed typical preferred embodiments of the inventive subject matter and, although specific terms are employed, they are used in a generic and descriptive sense only and not for purposes of limitation, the scope of the inventive subject matter being set forth in the following claims.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. An orthodontic appliance used with teeth in a dental arch, comprising:
a pre-made first arch member segment selected from an array of pre-manufactured segments having different pre-determined sizes, shapes, lengths, angulations, and configurations, wherein the first arch member segment has two ends, at least one engaging portion, and at least one body portion;
one or more coupling units, wherein each coupling unit comprises a first surface custom-formed, based on three-dimensional intraoral scans of a patient's dentition, to fit a specific surface of at least one tooth in the dental arch and a second surface with one or more engagement structures, wherein the engagement structures are configured to removably attach one or more of an engaging portion and an end of the first arch member segment to the coupling unit without requiring removal of the coupling unit from the tooth; and
wherein motive force is generated by the first arch member segment when the first arch member segment is elastically deformed into attachment with one or more coupling units and the motive force is translated to at least one of the teeth in the dental arch through a coupling unit attached thereto.

2. The appliance of claim 1, wherein the engagement structures comprise a channel formed in the second surface of a respective coupling unit.

3. The appliance of claim 2, wherein the engagement structures further comprise a tab disposed across the channel.

4. The appliance of claim 1, wherein the orthodontic appliance further includes elastic ties disposed on the engagement structures to secure portions attached thereto.

5. The appliance of claim 1, wherein the engagement structures comprise at least one tapered wall formed in the second surface of a respective coupling unit.

6. The appliance of claim 1, wherein the first arch member segment is of a sinuous form.

7. The appliance of claim 1, wherein the coupling units are bonded to lingual surfaces of the teeth in a dental arch.

8. The appliance of claim 1, wherein the coupling units are bonded to buccal surfaces of the teeth in a dental arch.

9. The appliance of claim 1, wherein the orthodontic appliance further comprises a connection module attached to one or more of one of the body portions and one of the ends of the first arch member segment, wherein the connection module is rigid, semi-rigid, or flexible, and is configured to modify the motive force generated by the first arch member segment when attached to at least two coupling units.

10. The appliance of claim 9, wherein the connection module is removably attached to the first arch member segment.

11. The appliance of claim 9, wherein the connection module further comprises at least one of a hook, a recess, and an opening.

12. The appliance of claim 9, wherein the connection module is attached to two or more body portions of the first arch member segment.

13. The appliance of claim 9, wherein the connection module comprises a surface custom-formed, based on three-dimensional intraoral scans of a patient's dentition and gingiva, to fit the patient's oral anatomy.

14. The appliance of claim 1, wherein the orthodontic appliance further comprises an additional arch member segment and wherein the additional arch member segment is attached to at least one of the coupling units.

15. The appliance of claim 1, wherein the orthodontic appliance further comprises an additional arch member segment and a connection module attached to at least one of the first arch member segment and the additional arch member segment.

16. The appliance of claim 15, wherein the connection module is attached to one of the ends of the first arch member segment and one or more of a body portion and an end of the additional arch member segment, whereby additional motive force is generated by the elastic deformation of the first arch member segment resulting from the attachment of the connection module and the additional motive force is translated to at least one of the teeth through a coupling unit attached thereto.

17. The appliance of claim 15, wherein the connection module is attached to one of the body portions of the first arch member segment and one or more of a body portion and an end of the additional arch member segment, whereby additional motive force is generated by the elastic deformation of the first arch member segment and additional arch member segment resulting from the attachment of the connection module and the additional motive force is translated to at least one of the teeth through a coupling unit attached thereto.

18. The appliance of claim 15, wherein the connection module includes a surface custom-formed, based on three-dimensional intraoral scans of a patient's dentition and gingiva, to fit one or more of teeth and a gingival surface.

19. The appliance of claim 15, wherein the attachment of the connection module to at least one of the first arch member segment and the additional arch member segment is removable.

20. An orthodontic appliance used with teeth in a dental arch, comprising:
one or more pre-made connectors selected from an array of pre-manufactured connectors having different pre-determined sizes, shapes, lengths, angulations, and configurations, wherein each connector has a coupling end configured to interface a surface of a tooth in the dental arch and an engaging end;
a first arch component custom-designed based on three-dimensional imaging data of a patient's dentition and gingiva and comprising a first surface configured to fit one or more of the surfaces of at least one tooth and a gingival surface and a second surface having one or more engagement structures, wherein the engagement structures are configured to removably attach an engaging end of at least one of the pre-made connectors; and
wherein motive force is generated by the pre-made connectors when the pre-made connectors are elastically deformed into attachment with the first arch component and the motive force is translated to at least one of the teeth.

21. The appliance of claim 20, wherein the coupling end of at least one of the pre-made connectors is attached to a tooth through a coupling unit comprising a first surface custom-formed, based on three-dimensional intraoral scans of a patient's dentition, to fit a specific surface of at least one tooth in the dental arch and a second surface having one or more engagement structures attached to the coupling end of one of the pre-made connectors.

22. The appliance of claim 21, wherein the coupling end is removably attached to the one or more engagement structures of the coupling unit.

23. The appliance of claim 21, wherein the engagement structures of the coupling unit further comprise one or more of a channel, hook, recess, opening, and tapered wall in a surface thereof.

24. The appliance of claims 21, wherein the engagement structures of at least one coupling unit further comprise a tab disposed across a channel in a surface thereof.

25. The appliance of claim 21, wherein the orthodontic appliance further includes elastic ties disposed on the engagement structures of the coupling unit to secure portions attached thereto.

26. The appliance of claim 20, wherein the orthodontic appliance further includes elastic ties disposed on the engagement structures of the first arch component to secure portions attached thereto.

27. The appliance of claim 21, wherein the specific surface of a tooth includes the occlusal surface of the tooth.

28. The appliance of claim 20, wherein the engagement structures of the first arch component further comprise one or more of a channel, hook, recess, opening, and tapered wall in a surface thereof.

29. The appliance of claim 20, wherein the engagement structures of the first arch component further comprise a tab disposed across a channel in a surface thereof.

30. The appliance of claim 20, wherein the first arch component further comprises a recess on the first surface of the first arch component.

31. The appliance of claim 20, wherein the first arch component further comprises one or more openings.

32. The appliance of claim 20, wherein the surface of the tooth attached to the first arch component includes the occlusal surface of the tooth.

33. The appliance of claim 20, further comprising an additional arch component removably attached to a tooth of the dental arch through removable attachment to a connector affixed to the respective tooth.

34. An orthodontic appliance used with teeth in a dental arch, comprising:
a pre-made first arch member segment selected from an array of pre-manufactured segments having different pre-determined sizes, shapes, lengths, angulations, and configurations, wherein the first arch member segment has two ends, at least one engaging portion, and at least one body portion;
one or more first coupling units, wherein each coupling unit comprises a first surface custom-designed based on three-dimensional imaging data of a patient's dentition to fit a specific surface of at least one tooth in the dental arch and a second surface with one or more engagement structures, wherein the engagement structures are configured to removably attach one or more of an engaging portion and an end of the first arch member segment to one of the first coupling units without requiring removal of the first coupling unit from the tooth;
a first arch component custom-designed based on three-dimensional imaging data of the patient's dentition and gingiva and comprising a first surface configured to fit one or more of the surfaces of at least one tooth and a gingival surface; and
a connection module attached to the first arch member segment and the first arch component, wherein the connection module is rigid, semi-rigid, or flexible, and is configured to modify the motive force generated by the first arch member segment when attached to at least one first coupling unit.

35. The appliance of claim 34, further comprising:
one or more pre-made connectors selected from an array of pre-manufactured connectors having different pre-determined sizes, shapes, lengths, angulations, and configurations, wherein each connector has a coupling end configured to interface a surface of a tooth in the dental arch and an engaging end;
one or more second coupling units, each comprising a first surface custom-designed based on three-dimensional imaging data of a patient's dentition to fit a specific surface of at least one tooth in the dental arch and a second surface with one or more engagement structures, wherein the engagement structures are configured to removably attach an engaging end of at least one of the pre-made connectors;
wherein the first arch component further comprises a second surface having one or more engagement structures configured to removably attach an engaging end of at least one of the pre-made connectors, thereby enabling the generation of additional motive forces through the pre-made connectors.

36. The appliance of claim 20, wherein the first arch component is rigid, semi-rigid, or flexible, and is configured to modify the motive force generated by at least one of the pre-made connectors when interfacing a surface of a tooth.

37. The appliance of claim 34, wherein the first arch component is rigid, semi-rigid, or flexible, and is configured to modify the motive force generated by at least one of the pre-made first arch member segment and the one or more pre-made connectors when attached thereto.

38. The appliance of claim 34, wherein the first arch component and the connection module are formed as a single, materially continuous structure.
